(19) United States
(12) Patent Application Publication
(10) Pub. No.: US 2012/0008014 A1
(43) Pub. Date: Jan. 12, 2012

(54) IMAGING APPARATUS, METHOD FOR CONTROLLING IMAGING APPARATUS, AND COMPUTER PROGRAM PRODUCT FOR CONTROLLING IMAGING APPARATUS

(76) Inventor: Yoichi ITO, Tokyo (JP)

(21) Appl. No.: 13/173,485

(22) Filed: Jun. 30, 2011

(30) Foreign Application Priority Data
Jul. 7, 2010 (JP) 2010-155035

(51) Int. Cl. H04N 5/76

(52) U.S. Cl. 348/231.3; 348/E05.031

(57) ABSTRACT

An imaging apparatus includes: an operation unit operated by a user; a setting unit that sets a function for image shooting through an operation of the operating unit; a guidance information storage unit that stores guidance information including at least either of a description about the function that can be set and an operational method for setting the function; a display unit that display the guidance information; a cumulative shot-frame counter that counts a cumulative number of shot frames, as a cumulative value of the number of image frames that have been shot; a proficiency level determining unit that determines the user's level of proficiency to be higher as the cumulative number of shot frames is large; and a display switching unit that switches between display and non-display settings of the guidance information on the display unit depending on determined level of proficiency.

### CROSS-REFERENCE TO RELATED APPLICATIONS

The present application claims priority to and incorporates by reference the entire contents of Japanese Patent Application No. 2010-155035 filed in Japan on Jul. 7, 2010.

### BACKGROUND OF THE INVENTION

1. Field of the Invention

Embodiments disclosed herein relate generally to an imaging apparatus for shooting an image, a method for controlling an imaging apparatus, and a computer program product for controlling an imaging apparatus.

2. Description of the Related Art

In regard to an imaging apparatus such as a digital camera, it generally employs a technology of offering various automatic modes such as an automatic determination of an optimum scene for shooting and an automatic execution of a macro mode for shooting so that even users who are not proficient in operation of a camera can shoot a good image just by simply pressing a shutter release. Furthermore, in order to help users who have nearly no idea of how to use functions but have a demand for shooting an image more creative than that shot by other people and for obtaining an image with an unusual atmosphere by changing the settings of a camera, some cameras adopt a technology of displaying guidance information, on an image monitor, giving a brief explanation about functions for shooting and showing an operational method of setting the functions.

Such guidance information is useful from the point of view that it tells a user an outline of functions or shows an operational method to a user. However, the displayed guidance information may irritate users who are proficient in operation of their cameras. For such a reason, many currently popular digital cameras give users a selection between display and non-display settings of the guidance information.

As one of various information processing devices having the function of displaying the guidance information, there is known a device that determines the user's level of proficiency from the operation status of the device and switches between display and non-display settings of the guidance information depending on the user's level of proficiency. For example, Japanese Patent Application Laid-open No. 2006-139332 discloses an operational assistant device mounted in a terminal device such as a personal computer, a personal digital assistant (PDA), a mobile phone or the like. The operational assistant device adopts a technology that determines the user's level of proficiency in use of functions so as to determine whether or not to perform the operational assistant, taking into consideration of a use history of a function to be provided with guidance such as the number of times the function was used in the past.

However, there arises the following problem when the technology disclosed in Japanese Patent Application Laid-open No. 2006-139332 is applied to an imaging apparatus such as a digital camera and thus the determination on the user's level of proficiency is made according to the technology. That is, it is general that a user, who just has purchased a camera, tests various functions of the camera in order to examine for the convenience of the functions built in the camera, without intentional actual shooting. In the course of testing the functions, unintended functions are likely to be set accidentally by mis-operation. In such a case, if the user's level of proficiency is determined according to the technology disclosed in Japanese Patent Application Laid-open No. 2006-139332, although a user who just has purchased a camera is actually low in the level of proficiency, the user is determined to be high in the level of proficiency from the selection history of functions; and thus there is a concern that the guidance information is not displayed in this case.

### SUMMARY OF THE INVENTION

It is an object of the present invention to at least partially solve the problems in the conventional technology.

According to an object of the present invention, there is provided an imaging apparatus including: an operation unit that is operated by a user; a setting unit that sets a function for image shooting through an operation of the operating unit; a guidance information storage unit that stores guidance information including at least either of a description about the function that can be set through the operation of the operation unit and an operational method for setting the function; a display unit that can display the guidance information; a cumulative shot-frame counter that counts a cumulative number of shot frames, as a cumulative value of the number of image frames that has been shot; a proficiency level determining unit that determines the user's level of proficiency to be higher as the cumulative number of shot frames is large; and a display switching unit that switches between display and non-display settings of the guidance information on the display unit depending on the determined level of proficiency.

According to another object of the present invention, there is provided a method for controlling an imaging apparatus that includes: an operation unit that is operated by a user; a setting unit that sets a function for image shooting through an operation of the operation unit; a guidance information storage unit that stores guidance information including at least either of a description about the function that can be set through the operation of the operation unit and an operational method for setting the function; and a display unit that can display the guidance information, the method including: counting a cumulative number of shot frames which is a cumulative value of the number of frames of an image, the frames having been shot from the past; determining the user's level of proficiency higher when the cumulative number of shot frames are large; and switching between display and non-display settings of the guidance information on the display unit depending on the determined user's level of proficiency.

According to still another object of the present invention, there is provided a computer program product including a computer-readable medium including programmed instructions for controlling an imaging apparatus that includes: an operation unit that is operated by a user; a setting unit that sets a function for image shooting through an operation of the operation unit; a guidance information storage unit that stores guidance information including at least either of a description about the function that can be set through the operation of the operation unit and an operational method for setting the function; and a display unit that can display the guidance information, wherein the instructions, when executed by a computer, cause the computer to perform: counting a cumulative number of shot frames which is a cumulative value of the number of frames of an image, the frames having been shot from the past; determining the user's level of proficiency higher when the cumulative number of shot frames are large; and switching between display and non-display settings of the guidance information on the display unit depending on the determined user's level of proficiency.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a top view of a digital camera;

FIG. 1B is a front view of the digital camera;

FIG. 1C is a rear view of the digital camera;

FIG. 2 is a block diagram illustrating a configuration of a control system of the digital camera;

FIG. 3 is a functional block diagram illustrating a functional configuration related to a display function of guidance information that is implemented by a CPU through execution of a control program;

FIG. 4 is a diagram illustrating an example of a relation between a cumulative total number of shot frames and a level of proficiency;

FIG. 5 is a diagram illustrating an example of a display screen of guidance information;

FIG. 6 is a diagram illustrating an example of guidance information of each mode that can be set as one of flash modes of a digital camera;

FIG. 7 is a diagram illustrating an example of a relation between a level of proficiency and a selection between display and non-display settings of guidance information of each mode that can be set as one of flash modes of a digital camera;

FIG. 8 is a diagram for explaining an example of an counting-up operation for obtaining a cumulative number of shot frames per day and a reset operation of a cumulative shot-frame counter;

FIG. 9 is a functional block diagram illustrating a functional configuration related to a display function of guidance information that is implemented by a CPU according to a third example;

FIG. 10 is a functional block diagram illustrating a functional configuration related to a display function of guidance information that is implemented by a CPU according to a fourth example; and

FIG. 11 is a functional block diagram illustrating a functional configuration related to a display function of guidance information that is implemented by a CPU according to a fifth example.

### DETAILED DESCRIPTION OF THE PREFERRED EMBODIMENTS

Hereinafter, embodiments of an imaging apparatus, a method for controlling an imaging apparatus, and a computer program product for controlling an imaging apparatus will be described with reference to the accompanying drawings. Although the description below is made with an example in which the invention is applied to a digital camera, the invention also may be widely applied to other various imaging apparatuses having a function of displaying guidance information.

Configuration of Digital Camera

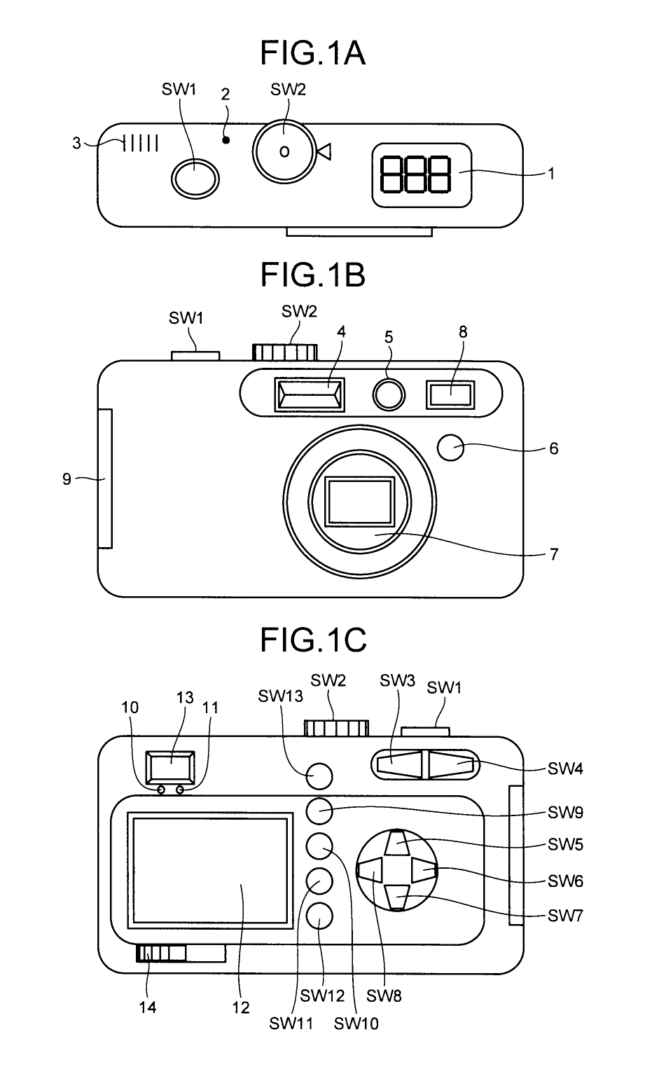

First, the specific configuration of a digital camera will be described. FIGS. 1A, 1B, and 1C show the outward appearances of a digital camera. FIG. 1A is a top view of the digital camera, FIG. 1B is a front view of the same digital camera, and FIG. 1C is a rear view of the same digital camera.

As shown in FIG. 1A, the digital camera includes a sub LCD 1 displaying the number of remaining still images which can be further shot on the surface thereof, a shutter release button SW1 that is depressed to shoot an image, a mode dial SW2, a microphone 2, and a speaker 3.

The shutter release button SW1 is configured as a two-step switch and thus allows a half-depression operation and a complete-depression operation. In the digital camera, AutoExposure/AutoFocusing (AE/AF) is activated by the half-depression operation of the shutter release button SW1; and automatic white balancing (AWB) is activated by the complete-depression operation of the shutter release button SW1. Through these operations, the shooting of a still image is performed.

The mode dial SW2 is configured as a dial type switch. The modes of the digital camera are selected according to the position of the dial. The digital camera has many operation modes including shooting mode in which an image is shot; playback mode in which shot images are played back; and set-up mode in which camera settings are made. The digital camera also has many shooting modes including for example “still image shooting mode” and “scene mode.” Furthermore, examples of the “scene mode” include “subject chaser mode,” “portrait mode,” “face mode,” “sports mode,” “distant view mode,” “night view mode,” “high sensitivity mode,” “zoom macro mode,” “monochrome mode,” “sepia mode,” “inclination correction mode,” “text mode,” and “video clip shooting mode.” Switching among these modes is achieved through the operation of the mode dial switch SW2.

As shown in FIG. 1B, the digital camera according to this embodiment has, on the front surface, a flash light emitting unit 4 that emits flash light, an AF auxiliary light/self-timer lamp 5, a remote control light receiving unit 6 that receives an infrared ray signal from a remote control terminal, a lens barrel unit 7, and an optical finder (front surface) 8. The digital camera according to this embodiment has, on the side surface, a memory card slot through which a memory card 29 (described below) is inserted, and a battery containing unit that contains a battery 25 therein. The memory card slot and the battery containing unit are blocked by a cover 9. The digital camera according to this embodiment further has, on the side surface, an AV output terminal 21 used to connect the digital camera to an external display apparatus such as a television, a USE terminal 22 (described below) used to connect the digital camera to an external information terminal such as a personal computer and the like.

As shown in FIG. 1C, the digital camera according to this embodiment has, on the rear surface, an AF LED 10 that glows during the AF operation, a flash LED 11 that glows during the firing of flash light, an LCD monitor 12, an optical finder (rear surface) 13, and a power supply switch 14.

The LCD monitor 12 is an image monitor that can display a color image thereon. This is used as an image display panel for displaying shot images during the playback mode, and also as a user interface display panel that allows a user to operate various settings during the set-up mode. This is also used as an image confirming finder for displaying a live view during the shooting mode, if needed.

Still on the rear surface, the digital camera according to this embodiment further includes various switches including, for example, a zoom (wide) switch SW3, a zoom (tele) switch SW4, an up/flash switch SW5, a right switch SW6, a down/macro switch SW7, a left/image confirming switch SW8, a self-timer/delete switch SW9, a menu switch SW10, an OK switch SW11, a display switch SW12, and a quick access switch SW13.

The zoom (wide) switch SW3 and zoom (tele) switch SW4 serve as switches for giving instructions regarding zooming operations of the digital camera. The digital camera performs zooming to enter a wide angle mode when the zoom (wide) switch SW3 is operated during the shooting mode and to enter a telephoto mode when the zoom (tele) switch SW4 is operated during the shooting mode. As a result, the focal length of a lens is changed. Furthermore, during the playback mode, the image is displayed as reduced on the LCD monitor 12 if the zoom (wide) switch SW3 is operated during the playing back; and is displayed as magnified on the LCD monitor 12 if the zoom (tele) switch SW4 is operated during the playing back.

The up/flash switch SW5 is operated to switch among various flash modes (flash-off, automatic, red-eye reduction, forced flashing, slow-synchro, etc.) and to move a cursor on the LCD monitor 12 upward. The right switch SW6 is operated to move the cursor on the LCD monitor 12 rightward. The down/macro switch SW7 is operated to perform macro mode shooting or to move the cursor on the LCD monitor 12 downward. The left/image confirming switch SW8 is operated to confirm the shot image on the LCD monitor 12, move the cursor on the LCD monitor 12 leftward, and the like.

The self-timer/delete switch SW9 is operated to operate the self-timer and delete the image displayed on the LCD monitor 12. The menu switch SW10 is operated to give an instruction for switching from a normal screen of each mode to a menu screen, which is displayed thereon. The OK switch SW11 is operated to give an instruction for confirming and executing the selected item.

The display switch SW12 is operated to give an instruction for changing the display status of the screen of the LCD monitor 12, for example, for switching between display and non-display settings of a mark on the LCD monitor 12. The screen display of the LCD monitor 12 changes in the order of histogram display→grid guide display→mark display off→LCD monitor off→normal mark display→histogram display→ . . . , each time the display switch SW12 is operated during the shooting mode. Meanwhile, during the playback mode, the screen display of the LCD monitor 12 changes in the order of histogram display→highlight display→mark display off→normal mark display→histogram display→ . . . , each time the display switch SW12 is operated. The display switch SW12 also functions as a switch that gives an instruction for canceling the input operation or for returning the operation state to the directly previous state.

The quick access switch SW13 is operated to instantly select registered menu.

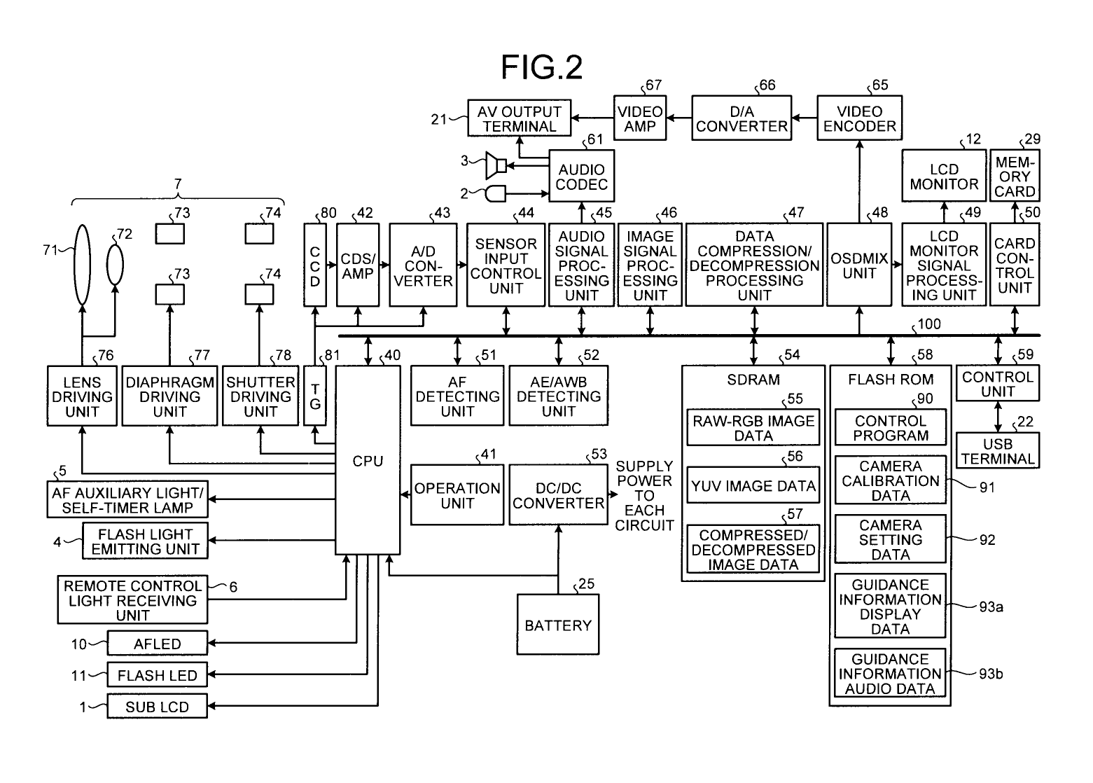

FIG. 2 is a block diagram illustrating the configuration of a control system of the digital camera according to the embodiment. The operations of the entire digital camera according to this embodiment are controlled overall by a Central Processing Unit (CPU) 40.

The CPU 40 controls overall the entire digital camera according to a predetermined control program 90, on the basis of operation signals which are input from the switches SW1 to SW13 (hereinafter, collectively referred to as an operation unit 41 when it is unnecessary to discriminate each switch from another) and on the basis of the output signal from the remote control light receiving unit 6. Specifically, the CPU 40 controls the overall operation of the digital camera, such as shooting of images and playing back of shot images. It also controls firing of flash light from the flash light emitting unit 4, lighting of the AF auxiliary light/self-timer lamp 5, the AF LED 10, and the flash LED 11, and displaying of the sub LCD 1. The operating power of the CPU 40 is supplied from the battery 25. The output from the battery 25 is also supplied to each internal circuit of the digital camera via a DC/DC converter 53.

A flash ROM 58 connected to the CPU 40 via a bus 100 stores the control program 90 to be executed by the CPU 40, various kinds of data necessary for the control, and various kinds of setting information regarding the operation of the digital camera such as information of user's settings (for example, camera calibration data 91 and camera setting data 92). The flash ROM 58 further stores guidance information giving a description about various functions regarding the image shooting of the digital camera and showing an operational method of setting each function. The guidance information is stored as guidance information display data 93a and guidance information audio data 93b on a function basis.

An SDRAM 54 is used as an operation work area of the CPU 40 and a temporary storage area for temporarily storing image data (Raw-RGB image data 55, YUV image data 56, and compressed/decompressed image data 57) or the like.

The lens barrel unit 7 includes a zoom lens 71 and a focus lens 72 that take an optical image of a subject, a lens driving unit 76 driving these lenses, a diaphragm 73, a diaphragm driving unit 77 controlling the diaphragm 73, a mechanical shutter 74, and a shutter driving unit 78 driving the mechanical shutter 74.

The lens driving unit 76, the diaphragm driving unit 77, and the shutter driving unit 78 are controlled to be driven according to the instruction from the CPU 40.

When the digital camera is powered on, the control program 90 stored in the flash ROM 58 is loaded into the SDRAM 54 so that the CPU 40 comes to have a control on operation of each unit of the apparatus according to the control program 90. In addition, data or the like necessary for the control are temporarily stored in the SDRAM 54.

The flash ROM 58 is a semi-non-volatile memory which is rewritable. Accordingly, the control program 90, various kinds of data necessary for control, user's settings (for example, camera calibration data 91 and camera setting data 92), and the like can be modified. This facilitates version up of the functions. Furthermore, along with the version up of the functions, this also enables provision of guidance information for newly added functions by storing the guidance information display data 93a and the guidance information audio data 93b regarding the newly added functions in the flash ROM 58.

In the digital camera, when the mode dial SW2 is operated to select the shooting mode, the operation mode of the digital camera is set into the shooting mode. This enables shooting of an image. When the operation mode of the digital camera is set into the shooting mode, the lens barrel unit 7 extends, which put the camera to be on standby.

In this shooting mode, light of a subject that has passed through the lenses (the zoom lens 71 and the focus lens 72) of the lens barrel unit 7 is imaged on the light receiving surface of a CCD 80 as a solid state imaging element through the diaphragm 73. Instead of the CCD 80, other types of imaging elements such as a CMOS image sensor may be used.

On the light receiving surface of the CCD 80, multiple photodiodes (light receiving elements) are two-dimensionally arranged through red (R), green (G), and blue (B) filters arranged according to a predetermined arrangement structure (Bayer, G stripe, or the like). The light of the subject that has passed through the lenses is received by respective photodiodes, and is then converted into an amount of a signal charge which depends on the amount of incident light. The signal charges stored in the respective photodiodes are sequentially read out as voltage signals (image signals) that correspond to the signal charges, in response to the driving pulses applied from a Timing Generator (TG) 81, and are then put to an analog processing unit (CDS/AMP) 42.

The analog processing unit (CDS/AMP) 42 samples and holds (i.e., performs correlated double sampling processing on) the input RGB signals for each pixel, amplifies them, and outputs the amplified signals to an A/D converter 43.

The A/D converter 43 converts the analog RGB signals output from the analog processing unit (CDS/AMP) 42 into digital RGB signals, thereby outputting the digital RGB signals. The digital RGB signals output from the A/D converter 43 are fed into the SDRAM 54 through a sensor input control unit 44 as the Raw-RGB image data 55.

An image signal processing unit 46 processes the Raw-RGB image data 55 fed into the SDRAM 54 according to the instruction from the CPU 40 to convert it into a luminance signal (Y signal) and color difference signals (Cr and Cb signals), thereby generating the YUV image data 56. That is, this image signal processing unit 46 functions as an image processing means including a coincidence circuit (a processing circuit, which interpolates a spatial deviation of color signals attributable to the arrangement of color filters in a single-board CCD in order to convert the color signals in a coincident manner), a white balance correction circuit, a gamma correction circuit, a contour correction circuit, and a luminance/color difference signal generating circuit, and the like. The image signal processing unit 46 performs signal processing on the input RGB signals, using the SDRAM 54 as a work area according to the instruction from the CPU 40, to generate the luminance signal and the color difference signals (luminance/color difference signals). The generated luminance/color difference signals are stored in the SDRAM 54 as the YUV image data 56.

At the time of outputting the shot image to the LCD monitor 12, the YUV image data 56 is transmitted from the SDRAM 54 to an OSDMIX unit 48.

The OSDMIX unit 48 superimposes on-screen display data such as characters and diagrams on the luminance/color difference signals of the input YUV image data 56 to synthesize them and outputs the synthesized signal to a video encoder 65 and an LCD monitor signal processing unit 49. Through this, required shooting information or the like is displayed along with the image data in an overlapping manner. The OSDMIX unit 48 combines the luminance/color difference signals of the YUV image data 56 with the guidance information display data 93a when the CPU 40 determines that the guidance information needs to be displayed and when the guidance information display data 93a to be displayed is read out from the flash ROM 58 and input, and then outputs the resultant to the LCD monitor signal processing unit 49. Through this, the guidance information is displayed on the LCD monitor 12 along with the image data in an overlapping manner.

The video encoder 65 converts the luminance/color difference signals of the input YUV image data 56 into a digital display output signal for display (for example, a color composite image signal of an NTSC system), and further converts the digital display output signal into an analog video output signal by means of a D/A converter 66.

A video AMP 67 performs 75Ω-impedance transformation on the analog video output signal output from the D/A converter 66, and outputs the resultant to an AV output terminal 21 for coupling the digital camera to an external display device such as a television. Through this, the image imaged in the CCD 80 is displayed on an external display device such as a television.

On the other hand, the LCD monitor signal processing unit 49 converts the luminance/color difference signals of the input YUV image data 56 into RGB signals in a format of an input signal for the LCD monitor 12, and then outputs the resulting RGB signals to the LCD monitor 12. Through this, the image captured in the CCD 80 is displayed on the LCD monitor 12.

The image captured in the CCD 80 is displayed in real time in such a way that the LCD monitor signal processing unit 49 receives regularly the image signal from the CCD 80, rewrites regularly the YUV image data 56 stored in the SDRAM 54 on the basis of the luminance/color difference signals generated from the image signal, and outputs the rewritten YUV image data 56 to the LCD monitor 12 and the AV output terminal 21. A user can confirm the field angle of the shot image by viewing the image (live view) displayed in real time on the LCD monitor 12.

The shooting of an image is performed by pressing the shutter release button SW1. Before shooting, a user operates the zoom (wide) switch SW3 and the zoom (tele) switch SW4 to adjust the zoom lens 71 when it is necessary to adjust the field angle. Through this operation, the field angle is adjusted.

If the shutter release button SW1 is pressed halfway, an R1 on-signal is input into the CPU 40 and the CPU 40 executes an AE/AF process.

First, the image signal from the CCD 80 is input into an AF detecting unit 51 and an AE/AWB detecting unit 52 through the sensor input control unit 44. The AE/AWB detecting unit 52 includes a circuit, which divides a screen into a plurality of areas (for example, 16×16 areas) and integrates R, G, and B signals per divided area. After the integration, the AE/AWB detecting unit 52 outputs the integration value to the CPU 40. The CPU 40 detects the brightness of a subject (also referred to as “subject brightness”) and calculates a proper exposure value (a shooting EV value) for shooting on the basis of the integration value obtained by the AE/AWB detecting unit 52. The CPU 40 also determines a diaphragm value and a shutter speed from the obtained exposure shooting EV value and a predetermined program diagram, and obtains a proper exposure amount by controlling the electronic shutter of the CCD 80 and the diaphragm driving unit 77 on the basis of the result from the determination.

In addition, the AE/AWB detecting unit 52 calculates the average integration value for each color of the R, G, and B signals per divided area during automatic correction of white balance. The calculation result is supplied to the CPU 40. The CPU 40 obtains an R/G ratio and a B/G ratio for each divided area from the R integration value, the B integration value, and the G integration value that are obtainable, and determines the type of a light source on the basis of the R/G and B/G distributions of the obtained R/G and B/G values in a color space. The CPU 40 controls gain values (white balance compensation values) for the R, G, and B signals respectively of the white balance compensating circuit on the basis of the white balance compensation values that are appropriate for the determined light source type so that, for example, the value of each ratio becomes about 1 (that is, the integration ratio of R:G:B for a single screen is about 1:1:1 (R:G:B≈1:1:1)), thereby to perform a correction on a signal of each color channel.

The AF detecting unit 51 includes a high pass filter that transmits only high frequency components of the G signal, an absolute value acquiring unit, an AF area extracting unit that extracts a signal of the interior of a predetermined focus area (for example, the center portion of a screen), and an integration calculating unit that integrates absolute value data in the AF area. The AF detecting unit 51 notifies the CPU 40 of data of the integration values thereof. The CPU 40 calculates a focus evaluation value (AF evaluation value) for each of a plurality of AF detection points while moving the focus lens 72 by controlling the lens driving unit 76, and thus determines the position of the lens where the evaluation value becomes maximum as an in-focus position. Next, the CPU 40 controls the lens driving unit 76 to move the focus lens 72 to the obtained in-focus position.

As described above, the AE/AF process is performed by the halfway depression operation of the shutter release button SW1. After that, if a user completely depresses the shutter release button SW1, an R2 on-signal is input to the CPU 40, and thus the CPU 40 starts shooting an image and performing a recording process. That is, the CPU 40 controls the diaphragm driving unit 77 to move the diaphragm 73 on the basis of the diaphragm value obtained through light metering, and also controls the shutter driving unit 78 to open/close the mechanical shutter 74 on the basis of the value of the shutter speed. That is, through this operation, the exposure time of the CCD 80 is controlled, and as a result the CCD 80 is exposed as controlled.

The image signal output from the CCD 80 is input into the SDRAM 54 through an analog processing unit (CDS/AMP) 42, the A/D converter 43, and the sensor input control unit 44. The image signal is converted into the luminance/color difference signals by the image signal processing unit 46, and is then stored into the SDRAM 54 as the YUV image data 56.

The YUV image data 56 stored in the SDRAM 54 is input into a compression/decompression processing unit 47 to be compressed in a predetermined compression format (for example, JPEG format); is then stored into the SDRAM 54 as the compressed/decompressed image data 57; is then changed into an image file in a predetermined image record format (for example, Exif format); and is finally recorded into the memory card 29 (for example, SD card) through a card control unit 50.

The image that has been recorded in the memory card 29 through the above processing may be displayed again on the LCD monitor 12 when the playback mode is selected through the operation of the mode dial SW2 and the operation mode is set to the playback mode. If the operation mode of the digital camera is set to the playback mode, the CPU 40 outputs a command to the card control unit 50 so as to read the image file recorded last time in the memory card 29. The compressed image data of the read-out image file is supplied to the compression/decompression processing unit 47, and is then decompressed to be uncompressed luminance/color difference signals. The uncompressed luminance/color difference signals are finally output to the LCD monitor 12 through the OSDMIX unit 48 and the LCD monitor signal processing unit 49. As such, the image recorded in the memory card 29 is played back and displayed on the LCD monitor 12.

In a case where the digital camera communicates with an external information terminal such as a personal computer (PC) by means of USB communication, the digital camera is connected to the external information terminal via the USB terminal 22. The CPU 40 communicates, by means of USB communication, with the external information terminal by controlling a USB control unit 59.

Audio signal data such as shutter sound and operation sound is stored in the flash ROM 58. The CPU 40 controls an audio signal processing unit 45 in such a manner that the audio signal data is output to an audio CODEC 61 through the audio signal processing unit 45. When it is determined that audio output of the guidance information is necessary, the CPU 40 reads the guidance information audio data 93b as an object to be voiced, from the flash ROM 58, and the guidance information audio data 93b is output to the audio CODEC 61 through the audio signal processing unit 45.

The audio CODEC 61 includes a microphone amplifier that amplifies the input audio signal and an audio amplifier for driving the speaker 3 provided in a built-in manner. The audio CODEC 61 is connected to the microphone 2 collecting an audio signal from a user and to the speaker 3 outputting the audio signal. The audio CODEC 61 drives the speaker 3 with use of the audio amplifier on the basis of the audio signal data input from the audio signal processing unit 45 and the guidance information audio data 93b. With this, shutter sound, operation sound, guidance information, and the like are output through the speaker 3.

Function of displaying guidance information

Next, in regard to the digital camera according to the present embodiment, a function of displaying the guidance information will be described below. The guidance information is information for assisting a user in operating the camera in a way of providing the user with a description of specific functions or a demonstration of an operational method of setting the specific functions, especially with respect to frequently used functions, among various functions which can be set through user's operation on the operating unit 41 and are used to shoot images. As candidates of functions for which guidance information is displayed, there are, for example, modes switched by operation of the mode dial SW2; flash modes switched by operation of the up/flash switch SW5; a macro function switched by operation of the down/macro switch SW7, a self-timer mode switched by operation of the self-timer/erase switch SW9, and the like. Regarding these functions, guidance information is displayed on the LCD monitor 12 as necessary.

Such guidance information is useful for users unfamiliar with operation of a digital camera in learning an outline of the functions and operational methods. However, users with much knowledge about the operational methods of a camera are likely to be irritated by the display of the guidance information on the LCD monitor 12. Accordingly, the digital camera according to this embodiment is configured in such a way that user's level of proficiency in operation of a digital camera is determined first, and as a result the guidance information is displayed when the user's level of proficiency is low but the guidance information is not displayed when the user's level of proficiency is high. Furthermore, in particular, the user's level of proficiency in operation of a digital camera is determined using information of the cumulative number of shot frames.

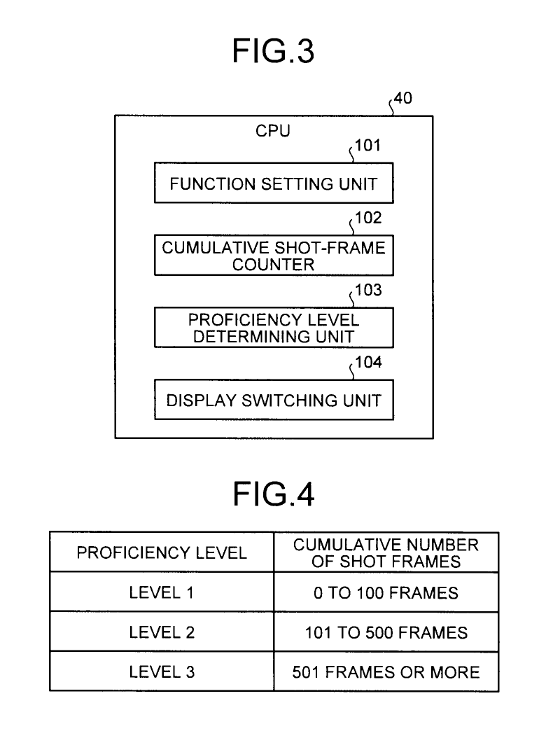

The display function of the guidance information of the digital camera according to the embodiment is implemented, for example, by execution of the control program 90 (a program component regarding the display function of guidance information) stored in the flash ROM 58 by the CPU 40. FIG. 3 is a functional block diagram illustrating the functional configuration related to the display function of guidance information which is implemented by execution of the control program 90 by the CPU 40. As shown in FIG. 3, the CPU 40 includes a function setting unit 101, a cumulative shot-frame counter 102, a proficiency level determining unit 103, and a display switching unit 104, as the functional configuration related to the display function of guidance information.

The function setting unit 101 sets various functions related to the image shooting when a user operates the operation unit 41. For example, if the “scene mode” out of the shooting modes is selected by operation of the mode dial switch SW2 and then the “subject chaser mode” is further selected, the function setting unit 101 sets the subject chaser mode so that the digital camera operates in the subject chaser mode.

The cumulative shot-frame counter 102 counts the total number of frames (the cumulative number of shot frames) that the user has captured. The cumulative number of shot frames counted by the cumulative shot-frame counter 102 is stored, for example, in the flash ROM 58 as camera setting data. The cumulative number of shot frames is counted in such a condition that the count is incremented by +1 per frame in a case of still image capturing, and the count is incremented by +1 per occurrence of video recording in a case of video capturing. Further, in a case of using an image storage format (for example, CIPA multi-picture format) in which a plurality of shot frames can be stored as one file, when there is present only a file, all image frames stored in the file are counted so as to produce the cumulative number of shot frames.

The proficiency level determining unit 103 determines the user's level of proficiency in operation of the digital camera on the basis of the cumulative number of shot frames counted by the cumulative shot-frame counter 102. The proficiency level determined by the proficiency level determining unit 103 is stored, for example, in the flash ROM 58 as camera setting data. This proficiency level is determined, for example, in three levels as shown in FIG. 4. Of proficiency levels, Level 1 is a low level, Level 2 is a middle level, and Level 3 is a high level. The digital camera is set to Level 1 as the proficiency level upon being shipped. If a user shoots actually an image with the digital camera and thus the cumulative number of shot frames increases, it is determined that the proficiency has improved by the proficiency level determining unit 103, so that the data of the flash ROM 58 is updated. Specifically, as shown in FIG. 4, for example, the proficiency level remains in Level 1 when the cumulative number of shot frames is 100 frames or less, but the proficiency level improves from Level 1 to Level 2 when the cumulative number of shot frames reaches 101 frames. After that, the proficiency level stays in Level 2 until the cumulative number of shot frames reaches 500 frames. The proficiency level improves from Level 2 to Level 3 when the cumulative number of shot frames reaches 501 frames. The case shown in FIG. 4 is of course just an example. The proficiency level may be divided into more levels, and the cumulative number of shot frames for each level may be set to an arbitrarily number.

The display switching unit 104 performs switching between display and non-display settings of guidance information for the function which is set by the function setting unit 101 through the operation of the operation unit 41, depending on the proficiency level that is determined based on the cumulative number of shot frames by the proficiency level determining unit 103, that is, on the basis of the proficiency level stored as the camera setting data in the flash ROM 58. Here, the proficiency level is determined in a plurality (three or more) of levels (like Level 1 to Level 3 as shown in the example of FIG. 4). The display switching unit 104 individually switches between display and non-display settings of guidance information for each function, depending on the proficiency level in use of each function, with respect to plurality of functions for which guidance information is prepared.

Specifically, referring to the example of FIG. 4, if the proficiency level is Level 1, whichever function, among a plurality of functions for which guidance information is prepared, is set by the function setting unit 101, the guidance information for the corresponding function is displayed. On the other hand, if the proficiency level is Level 3, whichever function, among a plurality of functions for which guidance information is prepared, is set by the function setting unit 101, the guidance information for the corresponding function is not displayed. Meanwhile, if the proficiency level is Level 2, only when each of predetermined some functions, among a plurality of functions for which guidance information is prepared, is set by the function setting unit 101, the guidance information for the corresponding function is displayed. With Level 2 of the proficiency level, when each of the other functions is set by the function setting unit 101, guidance information for the corresponding function is not displayed. When the proficiency level is divided into more than three levels, it is preferable to individually determine the relation between the proficiency level and the selection of display and non-display of guidance information for each function so that the number of functions for which guidance information is displayed decreases as the proficiency level improves (that is, the cumulative number of shot frames increases).

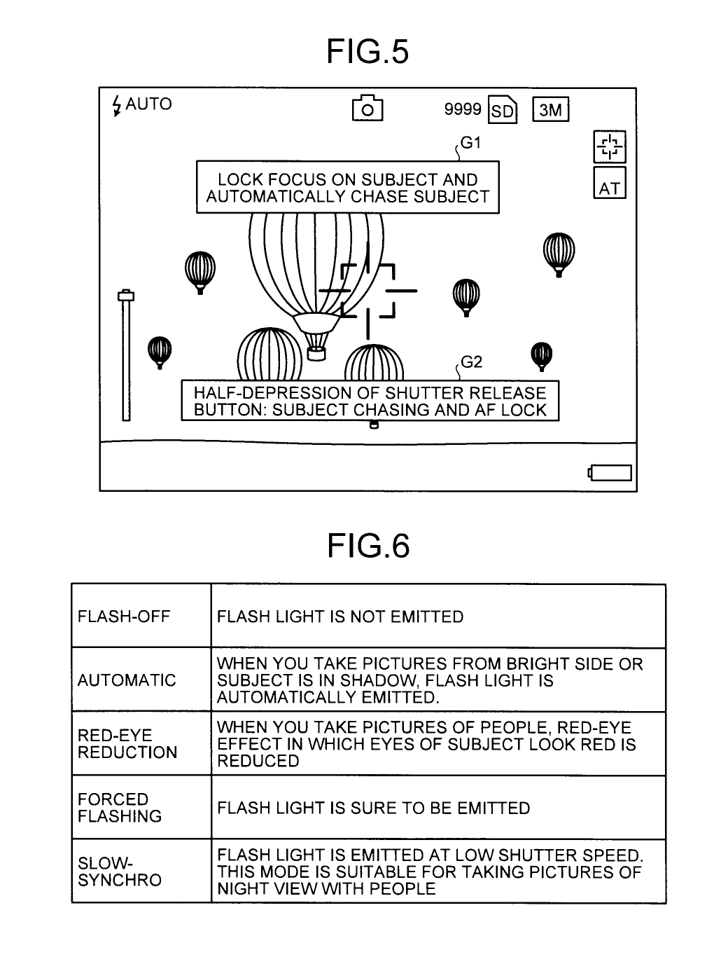

The display switching unit 104 reads out the guidance information display data 93a as a target to be displayed from the flash ROM 58, and supplies it to the OSDMIX unit 48 when it is determined that it is necessary to display the guidance information for the function set by the function setting unit 101. The OSDMIX unit 48 generates image data in which the guidance information display data 93a is contained and outputs it to the LCD monitor signal processing unit 49, if the guidance information display data 93a as a target to be displayed is supplied to the OSDMIX unit 48. As the LCD monitor signal processing unit 49 converts the image data (luminance/color difference signals) generated by the OSDMIX unit 48 into RGB signals and outputs the RGB signals to the LCD monitor 12, the image, in which guidance information G1 and guidance information G2 are superimposed, is displayed on the LCD monitor 12, for example, as shown in FIG. 5. FIG. 5 illustrates examples of the guidance information G1 and the guidance information G2 displayed on the LCD monitor 12 when the “subject chaser mode” is selected through the operation on the mode dial SW2.

The display switching unit 104 reads out the guidance information audio data 93b corresponding to the guidance information display data 93a serving as a target to be displayed from the flash ROM 58 along with the guidance information display data 93a when it is determined that it is necessary to display the guidance information of the function set by the function setting unit 101 and when the guidance information display data 93a as a target to be displayed is supplied to the OSDMIX unit 48. The read-out guidance information audio data 93b is supplied to the audio CODEC 61 through the audio signal processing unit 45. The audio CODEC 61 drives the speaker 3 with the audio amplifier on the basis of the guidance information audio data 93b, so that the voice corresponding to the guidance information displayed on the LCD monitor 12 is output from the speaker 3.

Furthermore, the display switching unit 104 reads out the proficiency level stored in the flash ROM 58 and supplies it to the OSDMIX unit 48 when it is determined that it is unnecessary to display the guidance information of the function set by the function setting unit 101; so that the proficiency level may be displayed on the LCD monitor 12 along with the image in an overlapping manner in place of the guidance information. In this case, a user can check the current proficiency level determined by the proficiency level determining unit 103 by viewing the LCD monitor 12, and therefore the user can clearly understand the reason why the guidance information is not displayed.

### FIRST EXAMPLE

Next, with a case of switching between modes of the flash mode as an example, an example of control on displaying guidance information by the CPU 40 will be described in more detail.

FIG. 6 illustrates an example of the guidance information of each mode that can be set as the flash mode of the digital camera. The digital camera according to the embodiment has, as described above, “flash-off,” “automatic,” “red-eye reduction,” “forced flashing,” “slow-synchro,” and the like as the flash mode. Each of these modes is selected by operation of the up/flash switch SW5.

If a user operates the up/flash switch SW5, the function setting unit 101 of the CPU 40 sets the mode selected by the operation as the flash mode of the digital camera. In this case, the display switching unit 104 determines whether or not to display the guidance information of the flash mode set by the function setting unit 101 on the LCD monitor 12, on the basis of the proficiency level stored in the flash ROM 58 at that time, that is, on the basis of the proficiency level determined based on the cumulative number of shot frames, which is counted by the cumulative shot-frame counter 102, by the proficiency level determining unit 103.

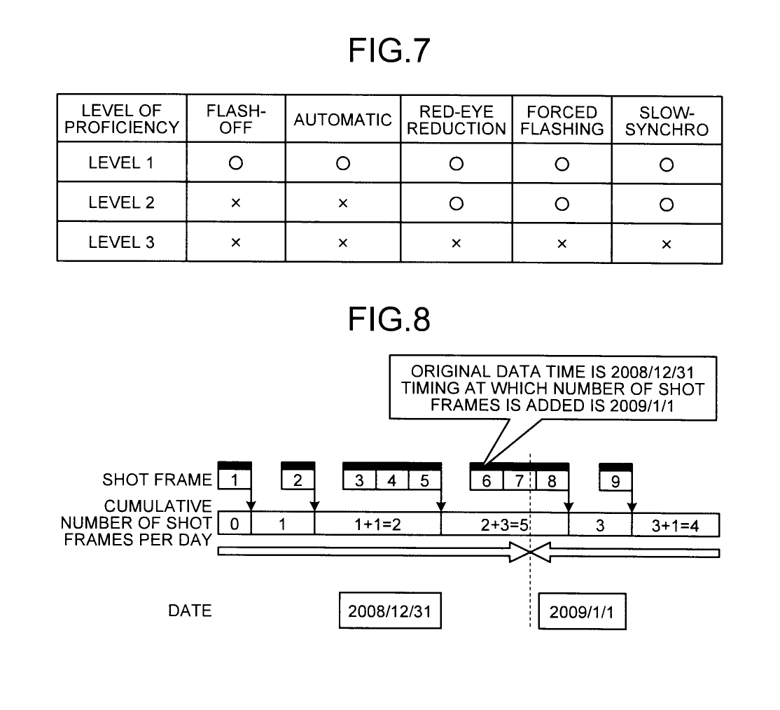

FIG. 7 is a diagram illustrating an example of the relation between a selection of display and non-display of the guidance information and the proficiency level for each mode that can be set as the flash mode of the digital camera. Here, it is assumed that the proficiency level is divided into three levels from Level 1 to Level 3 as shown in FIG. 4. The mark “O” in FIG. 7 represents the display of the guidance information and the mark “X” in FIG. 7 represents the non-display of the guidance information.

As illustrated in FIG. 7, in a case where the flash mode is set to “flash-off” or “automatic” by the function setting unit 101 through the operation of the up/flash switch SW5, the display switching unit 104 causes the guidance information to be displayed on the LCD monitor 12 only when the proficiency level stored in the flash ROM 58 at that time is Level 1, that is, when the proficiency level determined by the proficiency level determining unit 103 based on the cumulative number of shot frames which is counted by the cumulative shot-frame counter 102 is Level 1, but causes the guidance information not to be displayed on the LCD monitor 12 when the proficiency level is Level 2 or Level 3. However, in a case where the flash mode is set to any one of the “red-eye reduction,” “forced flashing,” “slow-synchro,” and the like by the function setting unit 101 through the operation of the up/flash switch SW5, the display switching unit 104 causes the guidance information to be displayed on the LCD monitor 12 when the proficiency level stored in the flash ROM 58 at that time is Level 1 or Level 2, but causes the guidance information not to be displayed on the LCD monitor 12 when the proficiency level is Level 3.

As described above, whether or not to display the guidance information is individually switched on a function basis, on the basis of the proficiency level in use of each function set by the function setting unit 101 (that is, for each mode of the flash modes in the above example). As such, in the above example, switching between display and non-display settings of the guidance information can be effectively performed according to the characteristics of the functions set by the function setting unit 101. For example, as for the relatively frequently used modes such as “flash-off” and “automatic,” the guidance information is not displayed after the proficiency level reaches Level 2, but as for the infrequently used modes such as “red-eye reduction,” “forced flashing,” “slow-synchro,” and the like, the guidance information is displayed until the proficiency level reaches Level 3.

### SECOND EXAMPLE

In the first Example, the description has been made on the premise in which the cumulative shot-frame counter 102 counts up the total number of frames that are shot by a user since the purchasing of the digital camera to give the cumulative number of shot frames and stores the counted total number of shot frames in the flash ROM 58 as the cumulative number of shot frames. However, the cumulative shot-frame counter 102 may reset the counted cumulative number of shot frames on a daily basis and the cumulative number of shot frames per day may be stored in the flash ROM 58.

FIG. 8 is a diagram for explaining an example of the details of an operation where the cumulative shot-frame counter 102 counts and resets the cumulative number of shot frames per day. In the example of FIG. 8, each of the shooting of the third to fifth frames and the shooting of the sixth to eighth frames produces a set of three frames (continuous shooting such as burst shooting, bracket shooting, or the like). In connection with the shooting of producing a set of multiple frames, the number of frames in a set is counted up in gross after the last frame of a set is shot. In the example of FIG. 8, the shooting date (Data Time Original of Exif IFD) of the sixth frame is 2008/12/31 but the date changes to 2009/1/1 after the completion of the shot of the eighth frame. Accordingly, the cumulative shot-frame counter 102 resets (clears the count to zero) the cumulative number of shot frames (five in the example of FIG. 8) that have been counted until that time and then counts up three frames.

In addition, the cumulative shot-frame counter 102 counts only the image files that have been shot but does not count the files deleted by a frame delete function, and files newly generated by a trimming function, an image size changing (resizing) function, and the like.

In a case where the digital camera is turned on a plurality of times within a day, the cumulative shot-frame counter 102 counts up by cumulating the number of all shot frames that are shot within the period in which the date upon the current turning-on is not changed from the date upon the previous turning-on, thereby producing the cumulative number of shot frames of the same date, and stores it in the flash ROM 58. The cumulative number of shot frames counted by the cumulative shot-frame counter 102 is reset (cleared to be zero) under the condition in which A) the date changes during a period from the turning-on of the digital camera to the turning-off of the digital camera and B) a user performs resetting on the date of the digital camera.

In the present Example, the cumulative shot-frame counter 102 counts up the cumulative number of shot frames per day in the above-described manner and stores the cumulative number of shot frames in the flash ROM 58 on a daily basis. Here, in similarly to the above example, if a user operates the up/flash switch SW5, the function setting unit 101 sets the mode selected by the operation as the flash mode of the digital camera. For this case, the display switching unit 104 determines whether or not to display the guidance information for the flash mode set by the function setting unit 101 on the LCD monitor 12, on the basis of the proficiency level stored in the flash ROM 58 at that time, that is, on the basis of the proficiency level determined by the proficiency level determining unit 103 based on the cumulative number of shot frames of that day that is counted by the cumulative shot-frame counter 102.

For example, when the flash mode set by the function setting unit 101 is the “flash-off” or “automatic,” the display switching unit 104 causes the guidance information to be displayed on the LCD monitor 12 only in a case where Level 1 is the proficiency level stored in the flash ROM 58 at that time, that is, the proficiency level determined by the proficiency level determining unit 103 based on the cumulative number of shot frames of that day that is counted by the cumulative shot-frame counter 102. However, the display switching unit 104 causes the guidance information not to be displayed on the LCD monitor 12 in a case where the proficiency level is Level 2 or Level 3. If the up/flash switch SW5 is operated so that the flash mode set by the function setting unit 101 is changed to any one of the “red-eye reduction,” “forced flashing,” and “slow-synchro,” the display switching unit 104 causes the guidance information to be displayed on the LCD monitor 12 only in a case where the proficiency level stored in the flash ROM 58 is Level 1 or Level 2 but causes the guidance information not to be displayed on the LCD monitor 12 in a case where the proficiency level stored in the flash ROM 58 is Level 3.

Next, if the date has changed when the digital camera is turned on since the previous turning-off of the digital camera, the cumulative shot-frame counter 102 resets the cumulative number of shot frames that has been counted until that time. Along with this, the proficiency level determined by the proficiency level determining unit 103 temporarily changes to a lower level. Then, as the cumulative shot-frame counter 102 counts up the cumulative number of shot frames of the day when the shooting is performed, the proficiency level determined by the proficiency level determining unit 103 improves to a higher level.

As such, according to the present example, the cumulative shot-frame counter 102 counts the cumulative number of shot frames on a daily basis, and the proficiency level determining unit 103 determines the proficiency level on the basis of the cumulative number of shot frames on a daily basis. Accordingly, the proficiency level determining unit 103 reflects, in determining the user's level of proficiency, user's habits, for example, the habit that a user is likely to forget the method of using the functions of the digital camera if the user has not used the digital camera for a long period of time since the last date of use of the digital camera, thereby determining the proficiency level more accurately and enabling more proper switching between display and non-display settings of the guidance information.

### THIRD EXAMPLE

In the above first and second Examples, for all of the functions for which guidance information is prepared, the display switching unit 104 performs switching between display and non-display settings of the guidance information depending on the common proficiency level determined by the proficiency level determining unit 103. However, the proficiency level determining unit 103 may determine the proficiency level on function basis and the display switching unit 104 may switch between display and non-display settings of the guidance information depending on the proficiency level in use of an individual function. In this case, if information of use history of each function that is described in Japanese Patent Application Laid-open No. 2006-139332 is further reflected into the Example, it is possible to more accurately determine the proficiency level in use of each function.

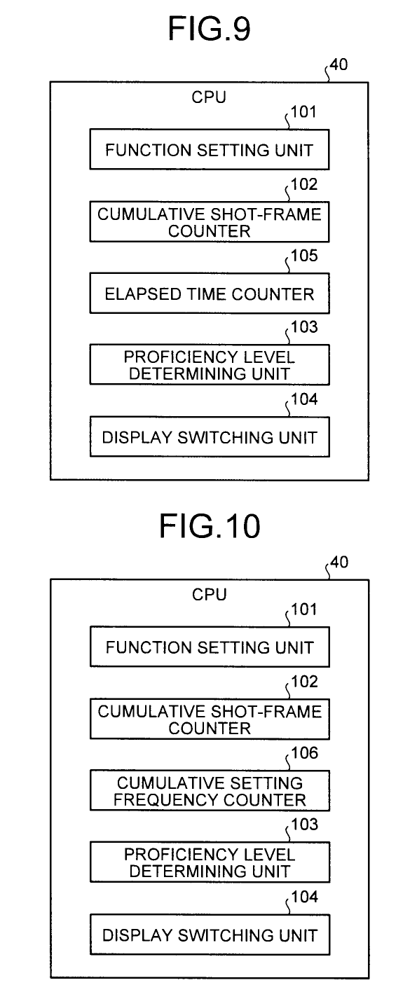

FIG. 9 is a functional block diagram illustrating a functional configuration related to a display function implemented by the CPU 40 of the present embodiment. In this embodiment, the CPU 40 further includes an elapsed time counter 105 in addition to the configuration illustrated in FIG. 3.

The elapsed time counter 105 counts the elapsed time that has passed since the preceding setting of each function is made by the function setting unit 101, with respect to all the functions for which guidance information is prepared. Information of the elapsed time for each function that is counted by the elapsed time counter 105 is stored, for example, in the flash ROM 58 as camera setting data.

In this Example, the proficiency level determining unit 103 determines a proficiency level on a function basis with respect to all the functions for which guidance information is prepared, on the basis of the cumulative number of shot frames counted by the cumulative shot-frame counter 102 and the elapsed time that is an interval from the time when the preceding setting of each function is made and is counted by the elapsed time counter 105. Specifically, as the cumulative number of shot frames, which is counted by the cumulative shot-frame counter 102, increases and the elapsed time, which is counted by the elapsed time counter 105, decreases; the proficiency level determining unit 103 determines a higher proficiency level for each function.

With respect to a certain function set by the function setting unit 101 through operation of the operation unit 41, the display switching unit 104 switches between display and non-display settings of guidance information depending on the proficiency level in use of the certain function which is determined by the proficiency level determining unit 103.

As described above, in the present Example, the proficiency level determining unit 103 determines the proficiency level in use of each function for which guidance information is prepared on the basis of the cumulative number of shot frames and the elapsed time that is an interval from that time when the preceding setting of each function is made; and the display switching unit 104 switches between display and non-display settings of the guidance information for a certain function that is set by the function setting unit 101 through the operation of the operation unit 41, depending on the proficiency level in use of the certain function that is determined by the proficiency level determining unit 103. Accordingly, it is possible to more properly switch between display and non-display settings of the guidance information on a function basis.

### FOURTH EXAMPLE

In the above third Example, the proficiency level in use of each function is determined by using information of the elapsed time that is an interval from the time when the preceding setting of each function is made as information of use history of each function. However, information of the cumulative number of times each function is set is also effective as the information of use history of each function that is used in determining the proficiency for each function.

FIG. 10 is a functional block diagram illustrating the functional configuration related to a display function of guidance information which is implemented by a CPU 40 according to this embodiment. According to this embodiment, the CPU 40 further includes a cumulative setting frequency counter 106 in addition to the configuration illustrated in FIG. 3.

The cumulative setting frequency counter 106 counts a total number of times (a cumulative number of times) a function is set by the function setting unit 101 on a function basis, with respect to all the functions for which guidance information is prepared. Information of the number of times each function is set, which is counted by the cumulative setting frequency counter 106, is stored in, for example, the flash ROM 58 as camera setting data.

In this embodiment, a proficiency level determining unit 103 determines, with respect to all functions for which guidance information is prepared, a proficiency level in use of each function, on a function basis, based on the cumulative number of shot frames counted by the cumulative shot-frame counter 102 and the cumulative number of times each function is set. Specifically, as the cumulative number of shot frames which is counted by the cumulative shot-frame counter 102 increases, and the cumulative number of times each function is set, which is counted by the cumulative setting frequency counter 106, increases, the proficiency level determining unit 103 determines a higher proficiency level in use of each function.

The display switching unit 104 switches between display and non-display settings of guidance information for the function, which is set by the function setting unit 101 through the operation of the operation unit 41, depending on the proficiency level in use of the corresponding function which is set by the proficiency level determining unit 103.

As described above, according to this Example, the proficiency level determining unit 103 determines the proficiency level in use of each function for which guidance information is prepared, on the basis of the cumulative number of frames and the cumulative number of times each function is set; and the display switching unit 104 switches between display and non-display settings of the guidance information for the function, which is set by the function setting unit 101 through the operation of the operation unit 41, depending on the proficiency level in use of the corresponding function which is determined by the proficiency level determining unit 103. Accordingly, it is possible to more properly switch between display and non-display settings of the guidance information on a function basis.

### FIFTH EXAMPLE

According to this embodiment, a proficiency level in use of each function is determined on a function basis using both information of elapsed time that is described in the above third embodiment and is an interval from the time when the preceding setting of each function is made, and information of the cumulative number of times each function is set that is described in the above fourth embodiment.

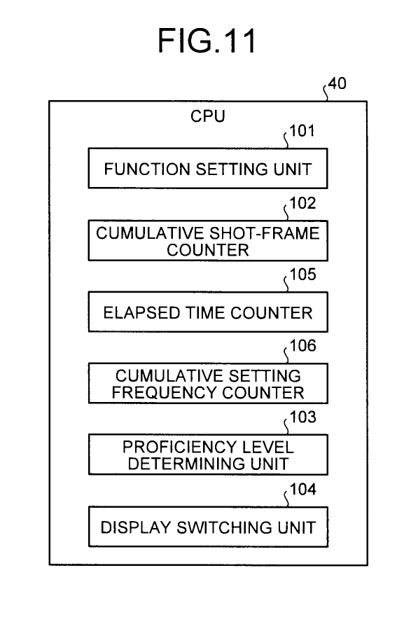

FIG. 11 is a functional block diagram illustrating the functional configuration related to a display function of guidance information which is implemented by a CPU 40 of this embodiment. In this embodiment, the CPU 40 further includes an elapsed time counter 105 and the cumulative setting frequency counter 106 in addition to the configuration illustrated in FIG. 3.

According to this embodiment, a proficiency level determining unit 103 determines a proficiency level in use of each function on a function basis, with respect to all functions for which guidance information is prepared, based on the cumulative number of shot frames which is counted by the cumulative shot-frame counter 102; the elapsed time that is an interval from the time when the preceding setting of each function is made and is counted by the elapsed time counter 105; and the cumulative number of times each function is set, which is counted by the cumulative setting frequency counter 106. Specifically, the proficiency level determining unit 103 determines that the proficiency level is higher in usage of each function, in a case when the cumulative number of shot frames which is counted by the cumulative shot-frame counter 102 is large; the elapsed time which is an interval from the time when the preceding setting of each function is made and is counted by the elapsed time counter 105 is short; and the cumulative number of times each function is set which is counted by the cumulative setting frequency counter 106 is large.

The display switching unit 104 switches between display and non-display settings of guidance information for the function, which is set by the function setting unit 101 through the operation of the operation unit 41, depending on the proficiency level in use of the corresponding function, which is determined by the proficiency level determining unit 103.

As described above, according to this Example, the proficiency level determining unit 103 determines, on a function basis, the proficiency level in use of each function for which guidance information is prepared: based on the cumulative number of shot frames; the elapsed time that has passed from the time when the preceding setting of each function is made; and the cumulative number of times each function is set, and the display switching unit 104 switches between display and non-display settings of the guidance information for the function which is set by the function setting unit 101 through the operation of the operation unit 41, depending on the proficiency level in use of the function, which is determined by the proficiency level determining unit 103. Accordingly, it is possible to properly switch between display and non-display settings of the guidance information on a function basis.

As described above while referring to specific Examples, in the digital camera according to the embodiments, the cumulative shot-frame counter 102 counts the cumulative number of shot frames; the proficiency level determining unit 103 determines a higher level of proficiency as the cumulative number of shot frames that is counted by the cumulative shot-frame counter 102 increases; and the display switching unit 104 switches between display and non-display settings of the guidance information for the function, which is set by the function setting unit 101 through the operation of the operation unit 41, depending on the proficiency level in use of the function, which is determined by the proficiency level determining unit 103. Accordingly, it is possible to properly switch between display and non-display settings of the guidance information by accurately determining the user's proficiency level in operation of the digital camera.

The proficiency level determining unit 103 determines the user's proficiency level in a plurality of levels for example three or more levels based on the cumulative number of shot frames which is counted by the cumulative shot-frame counter 102. Furthermore, the display switching unit 104 switches between display and non-display settings of the guidance information on a function basis, with respect to functions for which guidance information is prepared, depending on the proficiency level. Accordingly, the display switching unit 104 can effectively switch between display and non-display settings of the guidance information reflecting the characteristics of the function that is set by the function setting unit 101.

Furthermore, the display switching unit 104 can help a user with understanding the clear reason why the guidance information is not displayed by displaying the proficiency level instead of the guidance information, when it is determined that it is not necessary to display the guidance information for the function that is set by the function setting unit 101.

When it is necessary to display the guidance information on the LCD monitor 12, it is possible to make a user learn the overview and the use method of the function aurally as well as visually by outputting voice sound corresponding to the displayed guidance information through the speaker 3, thereby helping a user with operation of the digital camera in more effective way.

It is possible to accurately determine the proficiency level and thereby to properly switch between display and non-display settings of the guidance information by reflecting the user's habits such as a habit that a user tends to forget the use method of the function over a long period of time from the latest date the user used the digital camera, in determining the proficiency level in a way of resetting the cumulative number of shot frames that is counted by the cumulative shot-frame counter 102 on the daily basis.

Furthermore, it is possible to properly switch between display and non-display settings of the guidance information on a function basis, by additionally providing the elapsed time counter 105 that counts the elapsed time from the time of the preceding setting of each function for which guidance information is prepared, and by determining the proficiency level on a function basis in a manner such that the proficiency level determining unit 103 determines a higher proficiency level for the case of the larger cumulative number of shot frames, and the shorter elapsed time from the time when the preceding setting of each function is made.

Moreover, it is possible to more properly switch between display and non-display settings of the guidance information on a function basis, by additionally providing the cumulative setting frequency counter 106 that counts the cumulative number of times each function is set, for which guidance information is prepared, and by determining the proficiency level on a function basis in a manner such that the proficiency level determining unit 103 determines a higher proficiency level in use of each function for the case of the higher cumulative number of shot frames and the higher cumulative number of times each function is set.

Still furthermore, it is possible to properly switch between display and non-display settings of the guidance information on a function basis by additionally providing the elapsed time counter 105 that counts the elapsed time from the time of the preceding setting of each function for which guidance information is prepared and the cumulative setting frequency counter 106 that counts the cumulative number of times each function is set and by determining the proficiency level on a function basis in a manner such that the proficiency level determining unit 103 determines a higher proficiency level for the case of the larger cumulative number of shot frames, the shorter elapsed time from the time when the preceding setting of each function is made, and the larger cumulative number of times each function is set.

Specific embodiments and examples have been described above but the invention is not limited to the above-described embodiments and examples. The invention may be embodied by changing, altering, or modifying various elements within a scope that does not depart from the sprit of the invention when it is put into practice. For example, the configurations and operations of the digital camera according to the embodiments are provided only for examples and thus those may be changed, altered, and modified depending on uses and purposes.

According to the invention, the user's level of proficiency is determined to be higher as the cumulative number of shot frames increases. Accordingly, it is possible to accurately determine the user's level of proficiency and thus to properly switch between display and non-display settings of the guidance information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An imaging apparatus comprising:
an operation unit that is operated by a user;
a setting unit that sets a function for image shooting through an operation of the operating unit;
a guidance information storage unit that stores guidance information including at least either of a description about the function that can be set through the operation of the operation unit and an operational method for setting the function;
a display unit that can display the guidance information;
a cumulative shot-frame counter that counts a cumulative number of shot frames, as a cumulative value of the number of image frames that have been shot;
a proficiency level determining unit that determines the user's level of proficiency to be higher as the cumulative number of shot frames is large; and
a display switching unit that switches between display and non-display settings of the guidance information on the display unit depending on determined level of proficiency.

2. The imaging apparatus according to claim 1, wherein
the proficiency level determining unit determines the user's level of proficiency in a plurality of levels that are three or more levels based on the cumulative number of shot frames, and
the display switching unit switches between display and non-display settings of each item of a plurality of items of the guidance information corresponding to a plurality of the functions depending on the determined level of proficiency.

3. The imaging apparatus according to claim 1, wherein
the display switching unit causes the display unit to display the determined level of proficiency when the display switching unit does not cause the display unit to display the guidance information.

4. The imaging unit according to claim 1, further comprising:
an audio output unit that outputs voice sound corresponding to the guidance information when the display unit displays the guidance information.

5. The imaging unit according to claim 1, wherein the cumulative shot-frame counter resets the cumulative number of shot frames on a daily basis.

6. The imaging apparatus according to claim 1, further comprising:
an elapsed time counter that counts an elapsed time from a time when the function is set, wherein,
when the cumulative number of shot frames is large and the elapsed time is short, the proficiency level determining unit determines the user's proficiency higher.

7. The imaging apparatus according to claim 1, further comprising:
a cumulative setting frequency counter that counts a cumulative number of times the function is set, wherein
when the number of shot frames is large and the cumulative number of times the function is set is large, the proficiency level determining unit determines the user's proficiency higher.

8. The imaging apparatus according to claim 1, further comprising:
an elapsed time counter that counts an elapsed time from a time when the function is set; and
a cumulative setting frequency counter that counts a cumulative number of times the function is set, wherein
when the cumulative number of shot frames is large, the elapsed time is short, and the cumulative number of times the function is set is large, the proficiency level determining unit determines the user's level of proficiency higher.

9. A method for controlling an imaging apparatus that includes: an operation unit that is operated by a user; a setting unit that sets a function for image shooting through an operation of the operation unit; a guidance information storage unit that stores guidance information including at least either of a description about the function that can be set through the operation of the operation unit and an operational method for setting the function; and a display unit that can display the guidance information, the method comprising:
counting a cumulative number of shot frames which is a cumulative value of the number of frames of an image, the frames having been shot from the past;
determining the user's level of proficiency higher when the cumulative number of shot frames are large; and
switching between display and non-display settings of the guidance information on the display unit depending on the determined user's level of proficiency.

10. A computer program product comprising a computer-readable medium including programmed instructions for controlling an imaging apparatus that includes: an operation unit that is operated by a user; a setting unit that sets a function for image shooting through an operation of the operation unit; a guidance information storage unit that stores guidance information including at least either of a description about the function that can be set through the operation of the operation unit and an operational method for setting the function; and a display unit that can display the guidance information, wherein the instructions, when executed by a computer, cause the computer to perform:
counting a cumulative number of shot frames which is a cumulative value of the number of frames of an image, the frames having been shot from the past;
determining the user's level of proficiency higher when the cumulative number of shot frames are large; and
switching between display and non-display settings of the guidance information on the display unit depending on the determined user's level of proficiency.
